(19) United States
(12) Patent Application Publication
(10) Pub. No.: US 2011/0078017 A1
(43) Pub. Date: Mar. 31, 2011

(54) SYSTEMS AND METHODS FOR RATING AN ORIGINATOR OF AN ONLINE PUBLICATION

(76) Inventors: Selina Lam, Castro Valley, CA (US); Chien-Hui Sinead Yang, Taipei City (TW); Erik Beck Hansen, San Jose, CA (US)

(21) Appl. No.: 12/569,669

(22) Filed: Sep. 29, 2009

(51) Int. Cl. G06Q 10/00; G06Q 99/00; G06Q 30/00

(52) U.S. Cl. 705/14.45; 705/347

(57) ABSTRACT

Methods and systems to rate an originator of an online publication are provided. An example may include tracking user inputs associated with multiple online publications. Some examples may include using the tracked user inputs to calculate a publication rating for each of the online publications. In one example, the publication ratings may be used to calculate an originator rating, which may be provided for display and rates the originator.

### TECHNICAL FIELD

The subject matter relates to the field of online publishing. More specifically, but not by way of limitation, claimed subject matter discloses techniques for rating originators of information published in a network.

### BACKGROUND

All types of content, including advertisements, art, media, literary works, editorials, and the like, are made available for private and public consumption via computer networks such as the Internet. Those who receive the information published on networks such as the Internet may or may not be familiar with the originators of the information.

### BRIEF DESCRIPTION OF THE DRAWINGS

Some embodiments are illustrated by way of example and not limitation in the figures of the accompanying drawings in which:

FIG. 1 is a network diagram depicting an example of a network, within which example embodiments may be deployed;

FIG. 2 is a block diagram illustrating multiple modules that may be employed by a networked system, in accordance with an example embodiment;

FIG. 3 is a block diagram illustrating examples of Web interfaces, in accordance with an example embodiment;

FIG. 4 is a block diagram illustrating a further example of a Web interface, in accordance with an example embodiment;

FIG. 5 is an entity-interaction diagram illustrating examples of tables, in accordance with example embodiment;

FIG. 6 is a table illustrating an example of a publication rating table, in accordance with an example embodiment;

FIG. 7 is a table illustrating an example of a rating rules table, in accordance with an example embodiment;

FIG. 8 is a table illustrating an example of an originator rating table, in accordance with an example embodiment;

FIG. 9 is a flow diagram illustrating an example of a method for rating an originator of a publication, in accordance with an example embodiment; and

FIG. 10 shows a diagrammatic representation of machine in the example form of a computer system, in accordance with an example embodiment.

### DETAILED DESCRIPTION

Example systems and methods for rating an originator of a publication are described. In the following description, for purposes of explanation, numerous specific details are set forth in order to provide a thorough understanding of example embodiments. It will be evident, however, to one skilled in the art that the claimed subject matter may be practiced without these specific details.

Online publications such as online classified advertisements may be posted via the Internet on Web pages hosted by a networked publication system. Some sellers of goods and/or services who utilize the publication system may rarely post an advertisement for an item for sale, while other sellers may regularly post advertisements for items. Potential buyers may interact with and provide user input to Web pages presenting the posted advertisements, and in some example embodiments, the user inputs may be tracked and later used to calculate ratings for advertisements. Some user input types may include user selections on Web pages to view advertisements, watch advertisements, or recommend advertisements.

Various example embodiments disclosed herein describe calculating a publication rating that rates the effectiveness of each posted advertisement based on the number and type of user inputs associated with each of the advertisements. In some example embodiments, a seller may post several advertisements, and the publication rating associated with the seller's posted advertisements may be used to calculate an originator rating, which may rate the trustworthiness of the seller. Example structures and methodologies for practicing the claimed subject matter are described in more detail below.

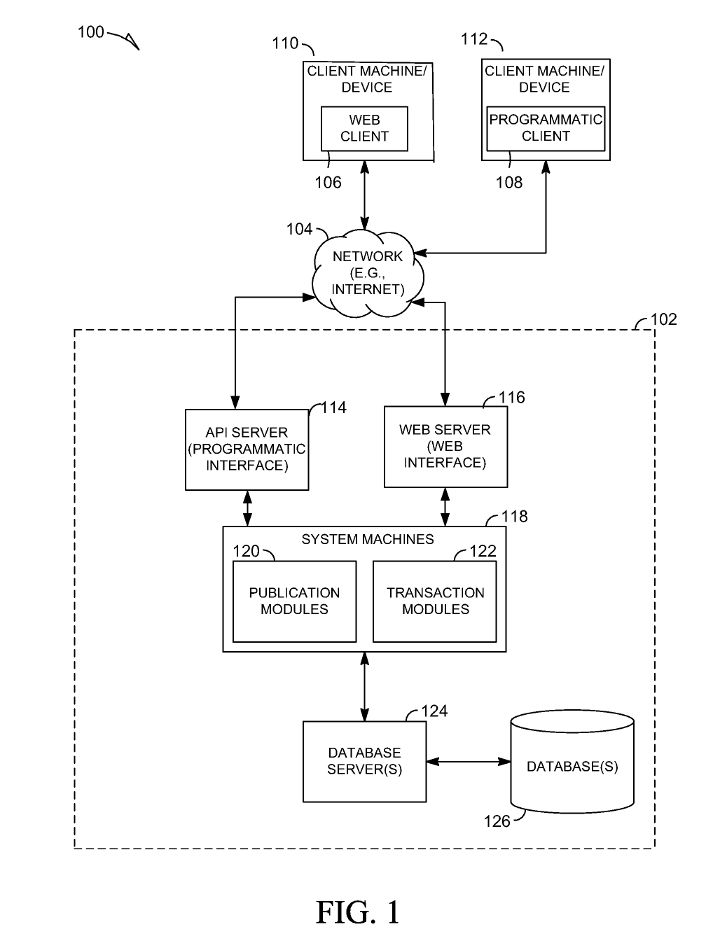

FIG. 1 is a network diagram depicting an example of a network 100, within which example embodiments may be deployed. A networked system 102, in the example form of a network-based publication or marketplace system, may provide server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash. State), and a programmatic client 108 executing on respective client machines 110 and 112.

A module interface 114 (e.g., an Application Program Interface (API) server) and a web interface 116 (e.g., a web server) are communicatively coupled to, and provide interfaces to, system machines 118. The system machines 118 host one or more publication modules 120 and transaction modules 122. The system machines 118 are, in turn, shown to be coupled to one or more database servers 124 that facilitate access to one or more databases 126.

The publication modules 120 and the transaction modules 122 may exist in a production environment, where the modules 120 and 122 provide functions and services associated with actual commercial or non-commercial activity relating to subject matter of value and real users or entities. Alternatively or additionally, the publication modules 120 and the transaction modules 122 may exist in a testing environment (e.g., testing of API calls) associated with fictitious commercial activity relating to fictitious subject matter and fictitious users or entities.

In various example embodiments, the publication modules 120 may provide a number of marketplace functions and services to users that access the networked system 102. The transaction modules 122 may in some embodiments provide a number of payment services and functions to the users. The transaction modules 122 may allow users to accumulate value (e.g., in a commercial currency, such as the U.S. dollar, or a proprietary currency, such as “points”) in accounts, and then later to redeem the accumulated value for products (e.g., goods or services) that are made available via the publication modules 120.

While the publication and transaction modules 120 and 122 are shown in FIG. 1 to form part of the networked system 102, it will be appreciated that, in alternative embodiments, the transaction modules 122 may form part of a payment service that is separate and distinct from the networked system 102. For some example embodiments, parties may settle payments without the use of transaction modules 122 or networked payment service, such as by settling payment by email, conventional mail, or in person.

Further, while the networked system 100 shown in FIG. 1 employs client-server architecture, the present subject matter is, of course, not limited to such an architecture, and could equally well find application in a distributed, or peer-to-peer, architecture system, for example. The various publication and transactions modules 120 and 122 could also be implemented as standalone software programs, which do not necessarily have networking capabilities.

The programmatic client 108 may access the various services and functions provided by the publication and transaction modules 120 and 122 via the module interface 114. In some example embodiments, the programmatic client 108 may allow a user operating the client machine 112 to originate online publications. The online publications may be of any type, including online publications for classified advertisements or auction item listings. For example, programmatic client 108 may be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

The web client 106 may access the various publication and transaction modules 120 and 122 via the web interface 116. For some example embodiments, a user of the client machine 110 may use the Web client 106 to view online publications (e.g., classified advertisements) originated by a user of the client machine 112 and/or originated by other sources. In an example embodiment, the user of the client machine 110 may view, via the Web client 106, ratings of online publications and/or ratings of online publication originators that have been generated by the publication modules 120 and the transaction modules 122. As discussed in more detail below, the ratings may relate, for example, to an effectiveness of an online publication or to trustworthiness of an originator.

The following discussion below includes descriptions of example structures and functions of the various modules that may be operated by the system machines 118.

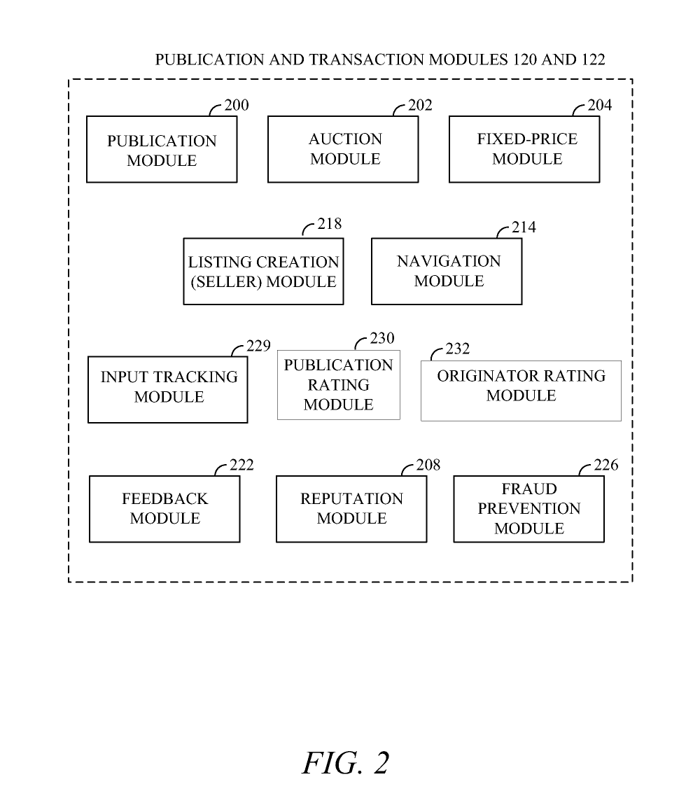

FIG. 2 is a block diagram illustrating publication and transaction modules 120 and 122 of FIG. 1 that, in some example embodiments, are provided as part of the networked system 102 of FIG. 1. Although some particular modules are described, it may be noted that a fewer or greater number of modules 120 and/or 122 may be employed by the networked system 102, and that more or less functionality may be provided by the example modules 120 and 122. For example, some networked systems 102 may provide payment service functionality.

The modules 120 and 122 may be communicatively coupled (e.g., via appropriate interfaces) to each other and to various data sources, so as to allow information to be passed between the modules 120 and 122 or so as to allow the modules 120 and 122 to share and access common data. The modules 120 and 122 may furthermore access one or more databases 126, for example, via the database server(s) 124 of FIG. 1, to retrieve data (e.g., from tables) for processing.

In some example embodiments, the modules 120 and 122 may be operated on dedicated or shared machines (not shown) that are communicatively coupled to enable communications. It may be noted that the modules 120 and 122 may be implemented with hardware, software, and/or a combination of hardware and software.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services.

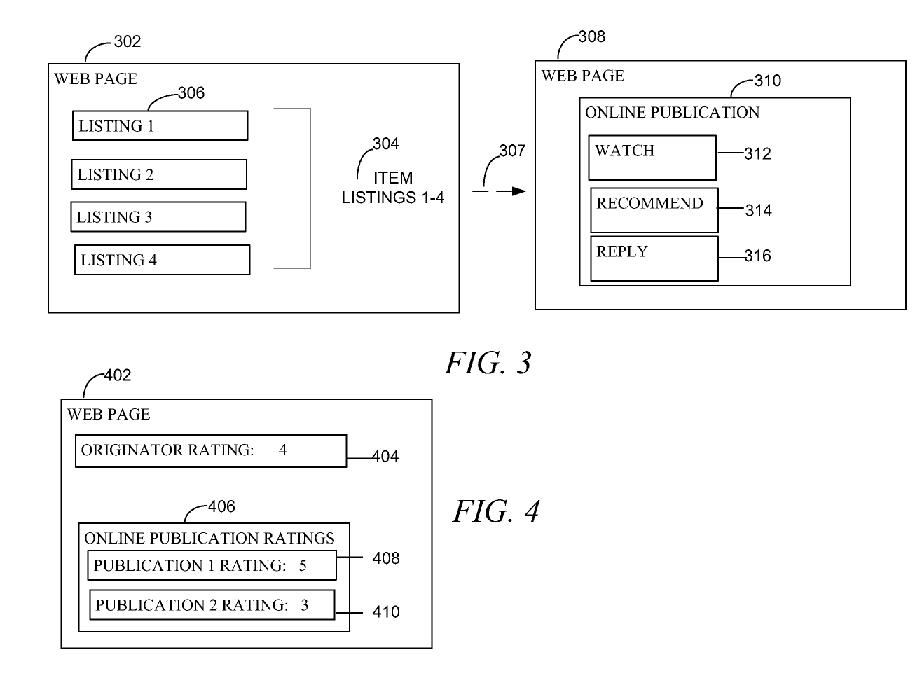

To this end, the modules 120 and 122 are shown to include at least one publication module 200 to publish information so as to allow users to receive online publications over the network 104 of FIG. 1. In an example embodiment, the publication module 200 may post online publications such as classified listings on Web pages that are served to clients via the Web interface 116. Example listings and online publications are discussed further below with respect to the FIGS. 3 and 4.

A number of fixed-price modules 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

The modules 120 and 122 may include one or more auction modules 202 which support auction-format listing and price setting mechanisms (e.g., English, Dutch, Vickrey, Chinese, Double, Reverse auctions etc.). The various auction modules 202 may also provide a number of features in support of such auction-format listings, such as a reserve price feature whereby a seller may specify a reserve price in connection with a listing and a proxy-bidding feature whereby a bidder may invoke automated proxy bidding.

Listing creation modules 218 may allow sellers conveniently to author listings pertaining to goods or services that they wish to transact via the networked system 102.

Further, in the publication and transaction modules 120 and 122 shown in FIG. 2, one or more feedback modules 222 may also assist originators or sellers with a number of activities that typically occur post-listing. For example, upon completion of an auction facilitated by one or more auction modules 202, a seller may wish to leave feedback regarding a particular buyer. To this end, a feedback module 222 may provide an interface to one or more reputation modules 208, so as to allow the seller conveniently to provide feedback regarding multiple buyers to the reputation modules 208. For some example embodiments, feedback provided by a user may be considered subjective information about another user. For example, subjective information provided by a buyer may be distinguished from a buyer's interactions or behavior associated with an online publication that may be used to infer characteristics of an originator of an online publication.

Reputation modules 208 allow users that transact, utilizing the networked system 102 of FIG. 1, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation modules 208 allow a user, for example through feedback provided by other transaction partners, to establish a reputation within the networked system 102 over time. Other potential trading partners may then reference such a reputation for the purposes of assessing credibility and trustworthiness.

A number of fraud prevention modules 226 implement fraud detection and prevention mechanisms to reduce the occurrence of fraud within the networked system 102.

Navigation of the networked system 102 may be facilitated by one or more navigation modules 214. For example, a search module (as an example of a navigation module) may enable key word searches of listings published via the networked system 102. A browse module may allow users to browse various categories and catalogue or inventory data structures according to which listings may be classified within the networked system 102. Various other navigation modules may be provided to supplement the search and browsing modules.

An example of how a user may browse a selection of listings for online publications is described now with respect to FIG. 3.

FIG. 3 is a block diagram illustrating examples of Web pages 302 and 308, in accordance with an example embodiment. FIG. 3 is shown to include a Web page 302 and a Web page 308 that may be viewed via an Internet browser. The arrow 307 represents the opening of the Web page 308 in response to a user interacting with the Web page 302.

The Web page 302 is shown to include item listings 304, which include selectable listing buttons one through four. Each listing button may be associated with a particular online publication. The selectable “LISTING 1” button 306 is one of the example item listings 304. A user may browse the item listings 304 on the Web page 302 and click the selectable “LISTING 1” button 306 if the user is interested in viewing an associated online publication. The selection may be referred to as a “view” of the online publication and may launch the Web page 308.

The Web page 308 illustrates an example online publication 310, in accordance with an example embodiment. An online publication 310 may include any information (e.g., a classified advertisement) that an originator of the online publication 310 wishes to disseminate to users of the networked system 102 of FIG. 1. In some example embodiments, the online publication 310 may include an advertisement describing goods and/or services offered for sale by the originator of the online publication 310.

The online publication 310 is shown to include a selectable “WATCH” button 312, a selectable “RECOMMEND” button 314, and a selectable “REPLY” button 316, which are described in more detail throughout the example embodiments below.

Referring again to FIG. 2, the input tracking module 229 may track user input to the Web page 302 and 308 of FIG. 3. In an example embodiment, a selection of a button on a Web page 302 or 308 is considered user input.

For example, the input tracking module 229 may count the number of “views” associated with an online publication. For some example embodiments, the input tracking module 229 may determine a number of “views” for an online publication by counting the number of times users select a selectable item listing button such as the “LISTING 1” button 306 of FIG. 3 to view the corresponding online publication 310.

The input tracking module 229 may count the number of “watches” associated with an online publication by counting the number of times users select a selectable watch button such as the “WATCH” button 312 of FIG. 3. A “watch” may represent that the user would like to monitor activity related to an online publication. In an example embodiment, selection of a selectable watch button may cause reference data associated with the online publication to be stored by the networked system 102 or by a user machine. The reference data may be subsequently accessed to permit the user to view the status of the online publication.

Input tracking module 229 may count the number of “recommendations” associated with an online publication by counting the number of times users select a selectable recommendation button such as the “RECOMMEND” button 314 of FIG. 3. A user may make a recommendation of an online publication to inform, for example, another user of an online publication that may be of interest. In some example embodiments, the recommendation information may be sent via e-mail. Alternatively or additionally, the recommendation information may be sent to a mobile device, posted on a social networking site, a blog, or provided by any other online or network publication.

Input tracking module 229 may count the number of replies associated with an online publication by counting a number of times users select a selectable reply button, such as the “REPLY” button 316 of FIG. 3. A user may reply to an online publication or advertisement by indicating an interest in further correspondence with the originator (e.g., further to the initial contact made via the online publication).

It may be noted that various types of input associated with an online publication may be tracked. For example, an online publication could be “flagged” by a user as being inappropriate, and the input tracking module 229 may keep a record of the flagging (e.g., by counting the number of flags, recording the nature of the flags, or recording the source of the flag). Alternatively or additionally, the online publication may be “tagged”; a tag may include a user-selected keyword, category, or characterization associated with the online publication that may be recorded or counted by the input tracking module 229. The flagging and tagging information or any other trackable user input may be input to the Web page via interface frames that are not shown in the example Web page 308 of FIG. 3.

Limits may be imposed on the amount of user input tracked by the input tracking module 229. Imposing limits on tracking certain user input may help to reject user input meant to fraudulently influence ratings. For example, the input tracking module 229 may limit the number of views, watches, and/or recommends tracked for each user by limiting the number of views to one or more views per hour for each user's IP address. Alternatively or additionally, user input from an originator of an online publication may not be tracked at any time so as to avoid fraudulent publication and/or originator promotion.

The publication rating module 230 may calculate publication ratings for online publications. In an example embodiment, a publication rating may relate to measuring an extent to which an online publication embodies a characteristic (e.g., effectiveness). A person having ordinary skill in the art will recognize that various characteristics of an online publication may be inferred from various types of user inputs. Publication ratings calculated by the publication rating module 230 may be based on the number and type of user inputs tracked by the input tracking module 229. The publication rating module 230 may employ an algorithm, equation, or logic structure that processes user input to generate a publication rating as the output.

The publication rating module 230 may normalize quantification of different types of tracked user input to a common unit that may be used as input to the algorithm, equation, or logic structure. In an example embodiment, the algorithm allots a particular weight or applies a particular factor to user input depending on a type of user input. For example, a 20 percent weight may be given to tracked “views,” 50 percent weight may be given to tracked “recommendations,” and a 30 percent weight may be given to tracked “watches.” A publication rating based on the above weights may be calculated to be the sum of the normalized and weighted user inputs.

For some example embodiments, the publication rating module 230 may apply a weight to a user input type that varies with current conditions. An example condition may include the time elapsed since an online publication was first posted. For example, an online publication may receive 70 percent of all of its views during the first 30 days of online publication. Views and recommendations made after 30 days may indicate intrinsic value or desirability of the online publication. In view of this indicator of potential value, the publication rating module 230 may assign a relatively larger weight to tracked views or recommendations that occur more than 30 days after the online publication was posted.

The originator rating module 232 may use the online publication ratings generated by the publication rating module 230 to generate an originator rating. For some example embodiments, the originator rating quantifies a characteristic (e.g., trustworthiness) of the originator of an online publication. The originator rating module 232 may weight, average, or apply any appropriate algorithm to generate the originator rating. For some example embodiments, the originator rating module 232 is to increase an originator rating if the originator has originated a number of online publications that meet or exceed a threshold number of online publications. Alternatively or additionally, an originator rating may be increased if the originator has purchased enhanced publication services (e.g., favored advertisement placement) from the networked system 102 of FIG. 1.

In some example embodiments, the networked system 102 may provide the publication ratings and the originator ratings to users to help users draw conclusions about, for example, online publications and/or their originators. In an example embodiment, the rating information may be published via Web page.

FIG. 4 is a block diagram, illustrating a further example of a Web interface, in accordance with an example embodiment. FIG. 4 is shown to include a Web page 402, which includes an originator rating 404 and an online publication rating 406. In an example embodiment, originator rating 404 is presented for visual display. The online publication rating 406 is to present one or more publication ratings 408 and 410. The originator ratings 404 and the publication ratings 408 and 410 may be calculated by the originator rating module 232 of FIG. 2 and the publication rating module 230, respectively, as described in the example embodiments above.

For some example embodiments, the publication rating module 230 and/or the originator rating module 232 may provide the calculated ratings to the Web interface 116 of FIG. 1 so that the Web page 402 of FIG. 4 may be served to various client machines connected, via the network 104 of FIG. 1, to the networked system.

The ratings shown in FIG. 4 need not be provided on a common Web page. For example, a publication rating for an online publication may be presented with the online publication itself (e.g., on the Web page 308 of FIG. 3). Alternatively or additionally, a rating for an online publication may be presented with search results or on a category browsing page, such as the Web page 302. For some example embodiments, the web page 402 of FIG. 4 may be a seller profile page that provides biographical and/or other information about a seller (e.g., a publication originator). As such, the profile page may include publication ratings 408 and 410 for all the seller's advertisements, and an overall originator rating 404 for the seller.

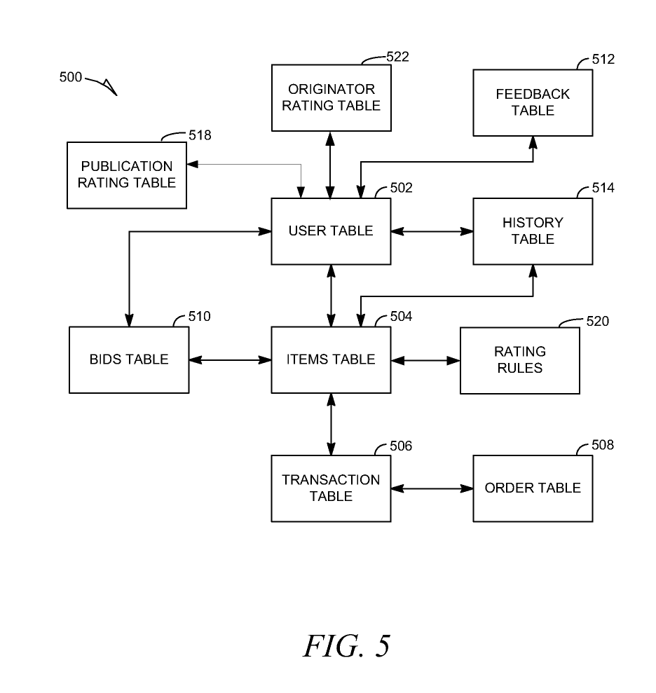

The modules of FIG. 2 may utilize and be supported by example tables stored by the database(s) 126 of FIG. 1. Example tables are shown in FIG. 5 and are discussed below.

FIG. 5 is an entity-interaction diagram, illustrating example tables 500, in accordance with an example embodiment. A user table 502 contains a record for each registered user of the networked system 102 of FIG. 1, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 500 also include an items table 504, which may maintain item records for goods and services that are available to be, or have been, transacted via the networked system 102. Each item record within the items table 504 may furthermore be linked to one or more user records within the user table 502, so as to associate a seller and one or more actual or potential buyers with each item record.

A transaction table 506 contains a record for each transaction (e.g., a purchase or sale transaction) pertaining to items for which records exist within the items table 504.

An order table 508 is populated with order records, each order record being associated with an order. Each order, in turn, may be with respect to one or more transactions for which records exist within the transaction table 506.

Bid records within a bids table 510 each relate to a bid received at the networked system 102 in connection with an auction-format listing supported by an auction module 202 of FIG. 2. A feedback table 512 is utilized by one or more reputation modules 208 of FIG. 2, in one example embodiment, to construct and maintain reputation information concerning users. A history table 514 maintains a history of transactions to which a user has been a party.

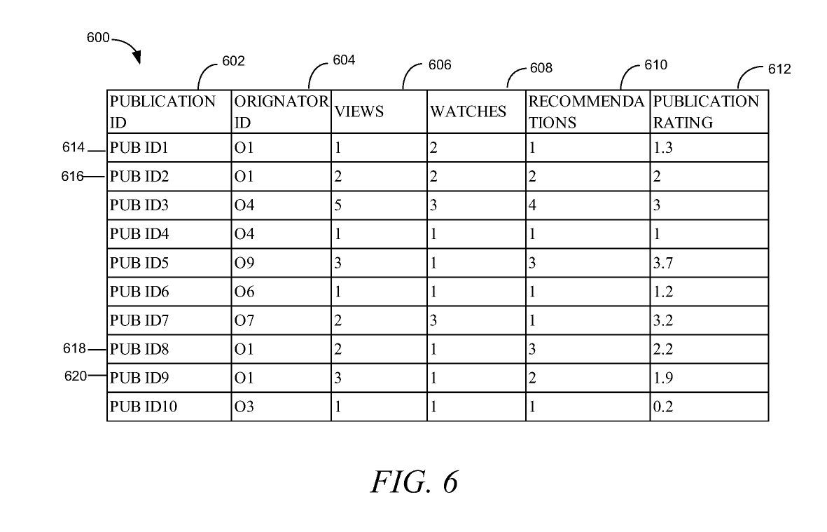

The publication rating table 518 is to store user input tracked by the tracking module 229 of FIG. 2, and to store calculated publication ratings calculated by the publication rating module 230. The rating rules table 520 is to keep a record for each user input type that sets forth a factors, weight, or other parameter to be applied to the tracked user input (e.g., after being normalized), under different conditions, when the publication rating module 230 of FIG. 2 or the originator rating module 232 calculates a rating. The originator rating table 522 is to store an originator rating that has been calculated by the originator rating module 232 of FIG. 2 for each originator. A discussion in FIGS. 6-8 provides further details regarding the publication rating table 518, the rating rules table 520 and the originator rating table 522.

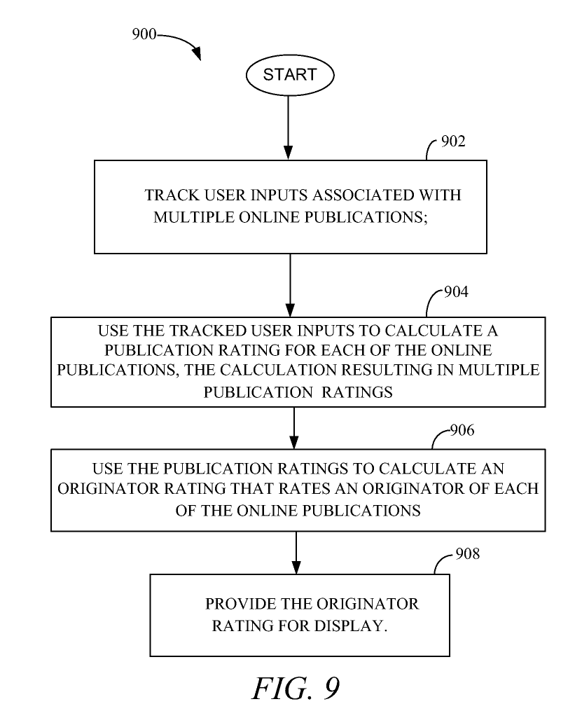

FIG. 6 is a table illustrating an example of a publication rating table 600, in accordance with an example embodiment. The publication rating table 600 is shown to include a publication identifier column 602, an originator identifier column 604, a views column 606, a watches column 608, a recommendations column 610, and a publication rating column 612. The intersections of rows 614, 616, 618, and 620 with the columns just described show specific rating-related values (e.g., number of views in column 606, etc.) corresponding to publication identifier in column 602. Some of those specific values are to be referenced below with respect to FIG. 9 in a description of an example method for providing an originator rating.

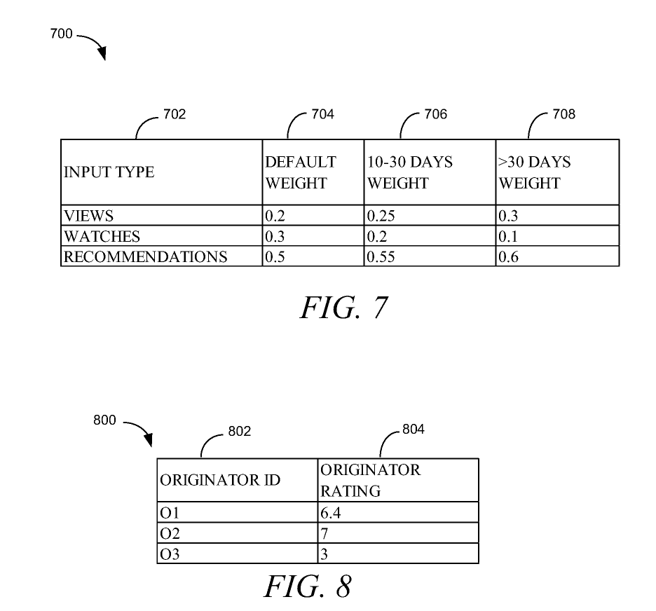

FIG. 7 is a table illustrating an example of a rating rules table 700, in accordance with an example embodiment. The rating rules table 700 is shown to include an input type column 702, a default weight column 704, a 10 to 30 days weight column 706, and a greater than 30 days weight column 708. In an example embodiment, values in the default weight column 704 are default factors to be applied to the values in the input type columns 606, 608, and 610 of FIG. 6 in the publication ratings calculation. The values in the 10 to 30 days weight column 706 are to be applied in the publication rating calculation when the online publication was posted greater than 10 days ago but fewer than 30 days ago. The values in the greater than 30 days weight column 708 are to be applied in the publication rating calculation when the online publication was posted greater than 30 days ago.

FIG. 8 is a table illustrating an example of an originator rating table 800, in accordance with an example embodiment. The originator rating table 800 is shown to include an originator identifier column 802 and an originator rating column 804.

Example embodiments illustrating the use of the example system structures and functions introduced above are now described with respect to the flow diagram of FIG. 9. FIG. 9 is a flow diagram illustrating an example method 900 for rating an originator of a publication, in accordance with an example embodiment.

At block 902, the example method 900 may include tracking user inputs associated with multiple online publications. As described above, the input tracking module 229 of FIG. 2 may track the multiple user inputs related to the online publications presented to users of the networked system 102. In various example embodiments, Web pages such as the Web pages 302 and 308, for various different online publications, may be displayed to multiple users connected to the networked system 102 of FIG. 1.

Referring to row 614 of FIG. 6, the input tracking module 229 may record in the publication rating table 600 for the online publication corresponding to the publication identifier “PUB ID1,” originated by an originator “O1,” the receipt of one view, two watches and one recommendation. For a different online publication, the input tracking module 229 may further record in the table 600 that an online publication corresponding to the identifier “PUB ID2” and the same originator “O1” has been viewed twice, watched twice, and recommended twice, as is displayed in row 616. Likewise, as further user input relating to online publications is received, the input tracking module 229 may write the relevant information to the appropriate row and column of the publication rating table 600. In this manner, the input tracking module 229 may track user inputs associated with multiple online publications.

Returning to FIG. 9, at block 904, the example method 900 may include using the tracked user inputs to calculate a publication rating for each of the online publications to generate multiple publication ratings. In an example embodiment, the publication rating module 230 may access (e.g., read from) the publication rating table 600 of FIG. 6 to obtain input to be processed in a publication rating calculation. The publication rating module 230 may, in some example embodiments, obtain any rating rules from the rating rules table 700 that may be appropriate to apply in a publication rating calculation. For example, for the online publication represented by the publication identifier “PUB ID8” of row 618 of FIG. 6, the default weights of column 704 in FIG. 7 may be applicable. In an example embodiment, calculating the publication rating may include summing the normalized and weighted user inputs. Based on this example algorithm and the default weights in column 704 of FIG. 7, the publication rating for “PUB ID8” is calculated as:

(2*0.2)+(1*0.3)+(3*0.5)=2.2.

For this example embodiment, the calculated publication rating would be 2.2. The default weights may be appropriate for calculating publication ratings for the online publications “PUB ID1” of row 614, “PUB ID2” of row 616, and “PUB ID3” of row 620 in FIG. 6. For those example online publications, the calculated publication ratings are 1.3, 2, and 1.9, respectively.

In some example embodiments, a publication rating quantifies the effectiveness of an online publication. For example, the publication rating for “PUB ID1” of 1.3 may be compared to the publication rating for “PUB ID2” of 2, and it could be inferred that the online publication represented by “PUB ID2” is relatively more effective than the online publication represented by “PUB ID1.”

Of course, confidence given to a calculated publication rating may depend on the number and type of user inputs associated with an online publication as well as weights assigned to different types of user inputs. For some example embodiments, the publication rating module 230 of FIG. 2 may calculate a confidence score, based on the number and types of user inputs associated with an online publication. For example, a relatively large number of user inputs may correspond to a higher confidence score and the publication rating module 230 may factor the confidence score into the publication rating calculation to increase or decrease the publication rating with an increase or decrease in input confidence.

In various example embodiments, publication rating module 230 may provide the calculated publication ratings to the Web interface 116 of FIG. 1, to display the publication ratings to users.

At block 906, the example method 900 may include using the online publication ratings to calculate an originator rating that rates the originator of each of the online publications. In an example embodiment, a rating may be sought for the originator having the originator identifier “O1” in column 604 of FIG. 6. Referring to FIG. 2, to rate originator “O1,” the originator rating module 232 may scan the originator identifier column 604 of FIG. 6 to identify all the publications originated by “O1.” The originator rating module 232 of FIG. 2 may collect, from column 612 of FIG. 6, all the publication ratings for the online publications originated by the originator “O1.”

In some example embodiments, the calculation of the originator rating for “O1” may be a sum or average of the applicable publication ratings. Alternatively or additionally, various weights and/or rating rules may be used to attempt to optimize the accuracy of the originator rating.

The originator rating module 232 may write the calculated originator rating to the row of the originator rating column 804 of FIG. 8 that corresponds to the originator “O1” in column 802 of FIG. 8. In an example embodiment, the originator rating may be calculated as the sum of the publications ratings for the originator's (e.g., “O1”) online publications, which would result in an originator rating of 6.4. This originator rating may be compared to the ratings of other originator ratings, to gauge, for example, the trustworthiness of the originator “O1.” As described with respect to publication ratings, confidence in the input data may be considered in the rating or assessment of an originator.

Still referring to FIG. 9, at block 908, the example method 900 may include providing the originator rating for display. As described above, the publication ratings and/or the originator rating may be output to users via Web page, such as the Web page 402 of FIG. 4, to allow users to make a decision about interacting, for example, with the originator of a publication.

Through practice of the techniques described above, an originator rating may be generated that may, for example, provide a measure of trustworthiness or credibility for an originator of a publication such as a seller who posts advertisements to online classifieds. Even after an originator's online publications have expired, and the online publication ratings are no longer available, the originator rating may remain available for inspection by users. In example embodiments in which an originator seldom posts advertisements (e.g., a seller may post one classified ad for a rare coin), the publication rating may be a more useful indicator of advertisement credibility or effectiveness than an originator rating would be.

Users who believe an online publication is effective and/or who believe that an originator of the online publication is trustworthy may be more likely to reply to an online publication if the user is interested in its subject matter. Thus, techniques disclosed above may promote the use and popularity of an online classified or marketplace service, which ultimately may result in increased revenue to the service.

Tracking the way that users interact or behave with a Web page including an online publication (e.g., views, watches, etc.) may provide relatively objective input that may be used to characterize an online publication. In the example embodiments described herein, the characteristics of effectiveness and trustworthiness have been described; however, the type of input to be tracked may be selected by a designer or programmer based on the characteristic about a publication that the designer wishes to measure.

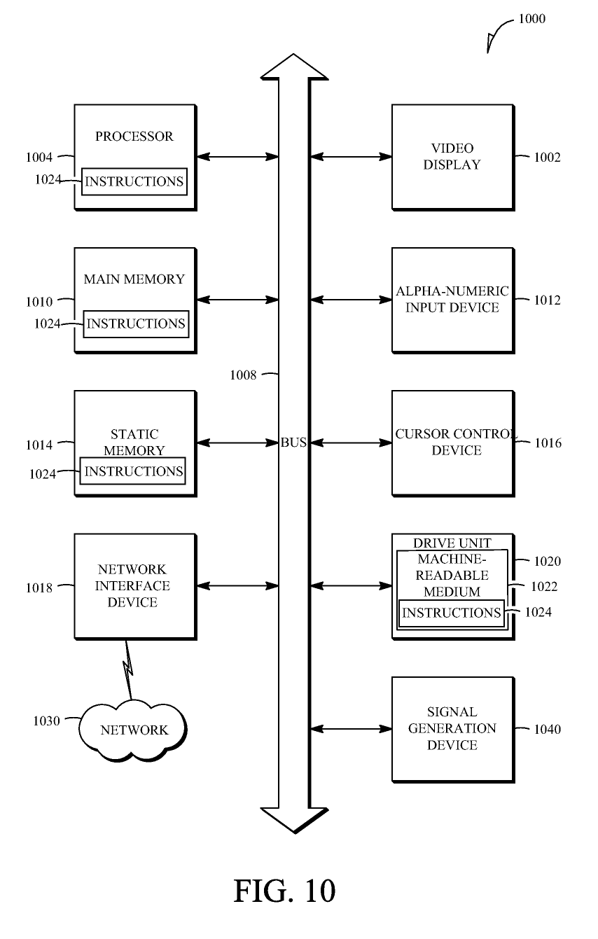

A machine and its features are described below with reference to FIG. 10. The machine may be representative of the machines described with respect to FIG. 1, including the client machines 110 and 112, and the machines operating the systems and modules of the networked system 102.

FIG. 10 shows a diagrammatic representation of machine in the example form of a computer system 1000 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a user machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1004 (e.g., a central processing unit (CPU), a graphics processing unit (GPU) or both), and a main memory 1010 and a static memory 1014, which communicate with each other via a bus 1008. The computer system 1000 may further include a video display unit 1002 (e.g., a liquid crystal display (LCD) or a cathode ray tube (CRT)). The computer system 1000 also includes an alphanumeric input device 1012 (e.g., a keyboard), a cursor control device 1016 (e.g., a mouse), a drive unit 1020, a signal generation device 1040 (e.g., a speaker) and a network interface device 1018.

The drive unit 1020 includes a machine-readable medium 1022 on which is stored one or more sets of instructions 1024 (e.g., software) embodying any one or more of the methodologies or functions described herein. The instructions 1024 may also reside, completely or at least partially, within the main memory 1010, the static memory 1014, and/or within the processor 1004 during execution thereof by the computer system 1000, the main memory 1010, the static memory 1014, and the processor 1004 also constituting machine-readable media.

The instructions 1024 may further be transmitted or received over a network 1030 via the network interface device 1018.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a set of instructions for execution by the machine and that cause the machine to perform any one or more of the methodologies of the claimed subject matter. The term “machine-readable medium” shall accordingly be taken to include, but not be limited to, solid-state memories, optical, and magnetic media.

Thus, a method and system to rate an originator of a publication has been described. Although the claimed subject matter has been described with reference to specific example embodiments, it will be evident that various modifications and changes may be made to these embodiments without departing from the broader spirit and scope of what is claimed. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A method of rating an originator that placed a plurality of online publications, the method comprising:
tracking a plurality of user inputs associated with the plurality of online publications;
using the plurality of tracked user inputs to calculate a publication rating for each of the plurality of online publications, the calculation resulting in a plurality of publication ratings;
using the plurality of publication ratings to calculate an originator rating that rates the originator; and
providing the originator rating for display.

2. The method of claim 1, wherein the tracking of the plurality of user inputs includes tracking a number of users that access at least one of the plurality of online publications.

3. The method of claim 1, wherein the tracking of the plurality of user inputs includes tracking a number of users that monitor at least one of the plurality of online publications.

4. The method of claim 1, wherein the tracking of the plurality of user inputs includes tracking a number of users that recommend at least one of the plurality of online publications to a further user.

5. The method of claim 1, wherein the tracking of the plurality of user inputs includes tracking up to a maximum number of the plurality of user inputs within a period of time.

6. The method of claim 1, wherein the using of the plurality of the tracked user inputs to calculate the publication rating comprises:
applying a first percentage weight to a first type of user input of the plurality of tracked user inputs;
applying a second percentage weight to a second type of user input of the plurality of tracked user inputs; and
calculating the publication rating based on a sum of a weighted first type of user input and a weighted second type of user input.

7. The method of claim 6, wherein at least one of the first percentage weight or the second percentage weight varies with time.

8. The method of claim 1, wherein the plurality of online publications include a plurality of advertisements, and the publication rating for each of the plurality of advertisement rates an effectiveness of each of the plurality of advertisements.

9. The method of claim 8, wherein the rating of the originator rates a trustworthiness of the originator.

10. A system to rate an originator that placed a plurality of online publications, the system comprising:
an input tracking module communicatively coupled to a network interface and configured to track a plurality of user inputs associated with the plurality of online publications;
a publication rating module configured to use the plurality of tracked user inputs to calculate a publication rating for each of the plurality of online publications, the calculation resulting in a plurality of publication ratings; and
an originator rating module configured to use the plurality of publication ratings to calculate an originator rating that rates the originator, the network interface to provide the originator rating to a network for display.

11. The system of claim 10, wherein the input tracking module is configured to track a number of users that access at least one of the plurality of online publications.

12. The system of claim 10, wherein the input tracking module is configured to track a number of users that monitor at least one of the plurality of online publications.

13. The system of claim 10, wherein the input tracking module is configured to track a number of users that recommend at least one of the plurality of online publications to a further user.

14. The system of claim 10, wherein the input tracking module is to track up to a maximum number of user inputs within a period of time.

15. The system of claim 10, wherein the publication rating module is configured to:
apply a first percentage weight to a first type of user input of the plurality of tracked user inputs;
apply a second percentage weight to a second type of user input of the plurality of tracked user inputs; and
calculate the publication rating based on a sum of a weighted first type of user input and a weighted second type of user input.

16. The system of claim 15, wherein at least one of the first percentage weight or the second percentage weight varies with time.

17. The system of claim 10, wherein the plurality of online publications include a plurality of advertisements, and the publication rating for each of the plurality of advertisement rates an effectiveness of each of the plurality of advertisements.

18. The system of claim 17, wherein the publication rating module is to rate a trustworthiness of the originator.

19. A machine-readable medium that stores instructions, which, when performed by a machine, cause the machine to perform operations comprising:
tracking a plurality of user inputs associated with a plurality of online publications, the plurality of online publications being placed by an originator;
using the plurality of tracked user inputs to calculate a publication rating for each of the plurality of online publications, the calculation resulting in a plurality of publication ratings;
using the plurality of publication ratings to calculate an originator rating that rates the originator; and
providing the originator rating for display.
